(19) United States
(12) Patent Application Publication
(10) Pub. No.: US 2024/0311730 A1
(43) Pub. Date: Sep. 19, 2024

(54) METHODS FOR SIMULATING CONVEYOR CYCLES ON MULTI-PRODUCT GENERAL ASSEMBLY LINES

(71) Applicants: GM GLOBAL TECHNOLOGY OPERATIONS LLC, Detroit, MI (US); TEXAS TECH UNIVERSITY, Lubbock, TX (US)

(72) Inventors: Dennis J. CARROLL, Leander, TX (US); Charles Alvin WILEY, Austin, TX (US); Vikram JEET, Greystones (IE); Alan FINNIN, Limerick (IE); Kegan Austin CLARK, Lake St. Louis, MO (US); Micheal MORROW, St. Peters, MO (US); David GUTMAN, Lubbock, TX (US); Lin CHEN, Lubbock, TX (US); Allan GURWICZ, Lubbock, TX (US); George FERNANDES, Lubbock, TX (US); Md ZAMAN, Lubbock, TX (US); Nhi NGUYEN, Lubbock, TX (US)

(21) Appl. No.: 18/120,779

(22) Filed: Mar. 13, 2023

(51) Int. Cl. G06Q 10/0635; G06Q 10/08

(52) U.S. Cl. CPC G06Q 10/0635; G06Q 10/08

(57) ABSTRACT

A method for simulating conveyors includes receiving conveyor content for each cycle, the conveyor content including over-cycle distributions each specific to a vehicle group at a footprint of each conveyor for a footprint cycle time, determining a cumulative probability, for each footprint cycle time, across all of the footprints of the conveyor, of one or more of the footprints of the conveyor having that cycle time or less, and determining an individual probability, for each footprint cycle time, across all of the footprints of the conveyor, of the conveyor having that cycle time. The method further includes receiving a vehicle dispatch strategy and generating an alert indicating an over-cycle risk for the strategy based on the individual probabilities, and/or performing a discrete event simulation of the conveyors using one of the individual probabilities for each cycle and for each conveyor. Other examples systems and methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods for simulating conveyor cycles on multi-product general assembly lines.

An assembly line may include multiple conveyors that advance vehicles or vehicle subassemblies through footprints in unison and at a constant speed. Each footprint of the assembly lines represents a location where, over a period of time, one or more tasks are completed in assembling vehicle content (e.g., a cycle) before the vehicle advances. This equates to a cycle time per footprint. If the tasks of assembling the vehicle content at one of the footprints of a conveyor is not finished within its cycle time, an over-cycle event occurs. In connection therewith, an alarm may be manually and/or automatically activated to notify supervisors, other workers, etc. of the over-cycle event or a possibility of an over-cycle event. If the alarm is not cleared, the conveyor (and possibly other upstream and/or downstream conveyors) stop.

### SUMMARY

A method is disclosed for simulating cycle times of conveyors of an assembly line. Each conveyor is configured to advance vehicles through a plurality of footprints representing a location where vehicle content is assembled. The method includes receiving, for each conveyor, conveyor content for each cycle, the conveyor content including over-cycle distributions each specific to a vehicle group at a footprint of each conveyor for a footprint cycle time. The method further includes for each cycle and for each conveyor, determining a cumulative probability, for each footprint cycle time, across all of the footprints of the conveyor, of one or more of the footprints of the conveyor having that cycle time or less, and determining an individual probability, for each footprint cycle time, across all of the footprints, of the conveyor having that cycle time. The cumulative probability for each footprint cycle time is determined based on the conveyor content for the conveyor, and the individual probability for each footprint cycle time is determined based on the cumulative probability for that footprint cycle time (N) and the cumulative probability for a previous footprint cycle time (N−1). The method further includes receiving at least one vehicle dispatch strategy for the assembly line and generating an alert indicating an over-cycle risk for the at least one vehicle dispatch strategy based on the determined individual probabilities.

In other features, the method includes generating a score for the received vehicle dispatch strategy based on the determined individual probabilities and optimizing the received vehicle dispatch strategy based on the generated score.

In other features, the received vehicle dispatch strategy includes a vehicle sequence and a staffing plan, and the method further includes evaluating a response to the alert to determine an impact of the response, wherein the response includes a change in the staffing plan or a change in the vehicle sequence of vehicle groups.

In other features, the method includes altering the alert based on the impact of the response.

In other features, for each cycle and for each conveyor, determining the cumulative probability, for each footprint cycle time, across all of the footprints of the conveyor, includes multiplying a set of the over-cycle distributions for that cycle time that are less than or equal to the cycle time.

In other features, for each cycle and for each conveyor, determining the individual probability, for each footprint cycle time, across all of the footprints of the conveyor, includes subtracting the cumulative probability for the previous footprint cycle time (N−1) from the cumulative probability for that footprint cycle time (N).

In other features, the method includes performing a discrete event simulation of the conveyors using one of the determined individual probabilities for each cycle and for each conveyor.

In other features, performing the discrete event simulation of the conveyors includes generating a random number for each conveyor and indexing the random number for each conveyor into an applicable cycle for that conveyor to obtain a simulated conveyor cycle time for each conveyor.

In other features, the method includes performing another discrete event simulation of the conveyors by generating another random number for each conveyor and indexing the other random number for each conveyor into an applicable cycle for that conveyor to obtain another simulated conveyor cycle time for each conveyor.

In other features, the method includes simulating a buffer between two of the conveyors based on a defined buffer capacity and a relationship between the end of one conveyor and the beginning of the other conveyor.

A method is disclosed for simulating conveyors of an assembly line. Each conveyor is configured to advance vehicles through a plurality of footprints representing a location where vehicle content is assembled. The method includes receiving, for each conveyor, conveyor content for each cycle, the conveyor content including over-cycle distributions each specific to a vehicle group at a footprint of each conveyor for a footprint cycle time. The method further includes for each cycle and for each conveyor, determining a cumulative probability, for each footprint cycle time, across all of the footprints of the conveyor, of one or more of the footprints of the conveyor having that cycle time or less, and determining an individual probability, for each footprint cycle time, across all of the footprints of the conveyor, of the conveyor having that cycle time. The cumulative probability for each footprint cycle time is determined based on the conveyor content for the conveyor, and the individual probability for each footprint cycle time is determined based on the cumulative probability for that footprint cycle time (N) and the cumulative probability for a previous footprint cycle time (N−1). The method further includes performing a discrete event simulation of the conveyors using one of the determined individual probabilities for each cycle and for each conveyor.

In other features, performing the discrete event simulation of the conveyors includes generating a random number for each conveyor and indexing the random number for each conveyor into an applicable cycle for that conveyor to obtain a simulated conveyor cycle time for each conveyor.

In other features, the method further includes performing another discrete event simulation of the conveyors by generating another random number for each conveyor and indexing the other random number for each conveyor into an applicable cycle for that conveyor to obtain another simulated conveyor cycle time for each conveyor.

In other features, the method further includes simulating a buffer between two of the conveyors based on a defined buffer capacity and a relationship between the end of one conveyor and the beginning of the other conveyor.

In other features, the method further includes receiving at least one vehicle dispatch strategy for the assembly line and generating an alert indicating an over-cycle risk for the vehicle dispatch strategy based on the discrete event simulation.

In other features, the received vehicle dispatch strategy includes a vehicle sequence and/or a staffing plan and the method further includes evaluating a response to the alert to determine an impact of the response, wherein the response includes a change in the staffing plan or a change in the vehicle sequence of vehicle groups.

In other features, evaluating the response to the alert to determine the impact of the response includes simulating performance of one of the footprints to have a zero percent probability of an over-cycle, and for each cycle and for each conveyor, determining the cumulative probability and the individual probability, for each footprint cycle time, across all of the footprints of the conveyor, based on the simulated performance of the footprint.

In other features, the method further includes receiving at least one vehicle dispatch strategy for the assembly line, generating a score for the vehicle dispatch strategy based on the discrete event simulation. and optimizing the vehicle dispatch strategy based on the generated score.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example system according to the present disclosure;

FIG. 2 is a functional block diagram of an example sequence of vehicles according to the present disclosure;

FIG. 3 is a functional block diagram of an example conveyor sequence with the vehicles of FIG. 2 advancing through footprints of a conveyor in cycles, according to the present disclosure;

FIG. 4 is a functional block diagram of an example table including determined individual probabilities of different cycles of FIG. 3, according to the present disclosure;

FIG. 5 is a functional block diagram of example tables for storing determined individual probabilities for cycles of different conveyors, according to the present disclosure;

FIG. 6 is an exemplary simulation diagram of an assembly line including multiple conveyors with footprints, according to the present disclosure;

FIG. 7 is an exemplary simulation diagram of the assembly line of FIG. 6, where each conveyor is treated as a single entity, according to the present disclosure;

FIG. 8 is a flowchart of a control process for simulating cycle times of conveyors of an assembly line, according to the present disclosure;

FIG. 9 is a flowchart of a control process for simulating conveyors of an assembly line, according to the present disclosure; and

FIG. 10 is a flowchart of a control process for performing discrete event simulations, according to the present disclosure.

In the drawings, reference numbers may be reused to identify similar and/or identical elements.

### DETAILED DESCRIPTION

An assembly line includes multiple conveyors that advance vehicles through footprints. As the vehicles advance along the assembly line, each footprint has its own task list of one or more tasks to be performed on each vehicle based on the vehicle's characteristics (e.g., options, body style, etc.). The task list for each footprint may vary (sometimes significantly) from vehicle to vehicle based on each particular vehicle and its characteristics. The amount of work required in each footprint varies based on the vehicle's characteristics. As such, the time per footprint required to complete tasks varies. For example, the same task (e.g., installing a six-speed transmission, etc.) at a footprint for a truck may take 10 seconds, but 15 seconds for a van. Additionally, the time per footprint required to complete tasks may vary due to a sequence of consecutive vehicles. For instance, a task at a footprint for a vehicle may be completed in an allotted time, and the same or a different task at the same footprint for another vehicle may be completed in an allotted time if the vehicles are not back-to-back. However, if the vehicles are back-to-back, the task at the footprint for the second vehicle (of the back-to-back vehicles) may take more than its allotted time. If the tasks of assembling the vehicle content at one of the footprints of a conveyor is not finished within the cycle time, the conveyor (and possibly other upstream and/or downstream conveyors) may stop. Conventional simulation techniques may be employed to simulate different sequences of vehicles advancing through the footprints of the assembly line to obtain a profile of throughput potential for an assembly line configuration and vehicle sequence. However, employing conventional simulation techniques is computationally infeasible and requires vast amounts of computing resources (e.g., processing, memory, etc.) to obtain an adequate profile of throughput potential for the plant configuration and vehicle sequence.

The systems and methods according to the present disclosure provide mechanisms for effectively simulating vehicles advancing through footprints of an assembly line by determining each conveyor's cycle time probability distributions for each cycle. The systems and methods may then leverage the determined cycle time probability distributions in discrete event simulations by using each cycle's cycle time probability distributions to treat each conveyor as a single entity. As a result, the computational complexity of simulating different sequences of vehicles advancing through footprints of the assembly line may be significantly reduced as compared to conventional simulation techniques. In this manner, the systems and methods enable the simulation of tens of thousands of vehicles (e.g., 40,000 vehicles, 50,000 vehicles, etc.) advancing through the assembly line of vast amounts of footprints (e.g., 400 footprints, 500 footprints, etc.) in a computationally feasible way while requiring significantly less computing resources as compared to conventional simulation techniques, thereby substantially reducing costs associated with each simulation.

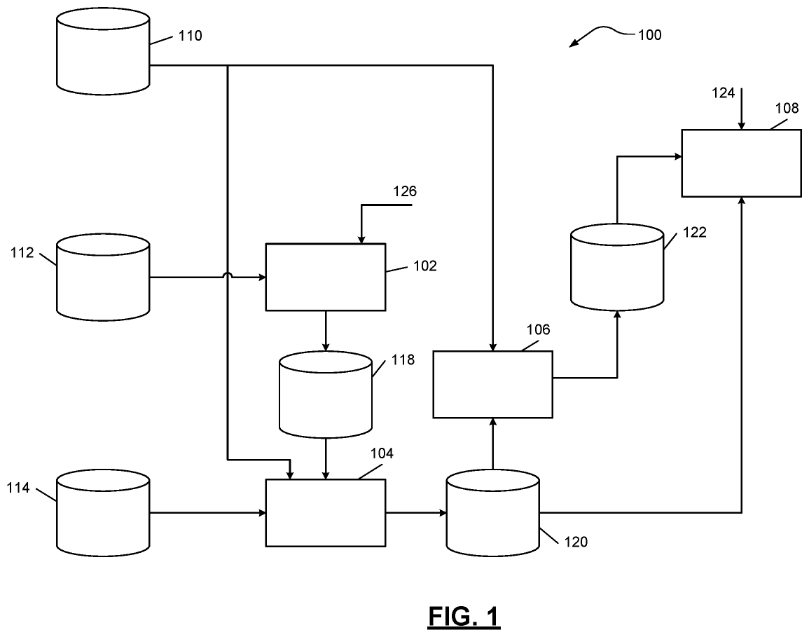

Referring now to FIG. 1, a functional block diagram of an example system 100 is presented. As shown, the system 100 generally includes various databases and modules for simulating vehicles advancing through footprints of an assembly line. For example, the modules of the system 100 may include a historical vehicle sequence module 102, a pass one simulator module 104, a pass two simulator module 106, and an evaluation module 108. The databases of the system 100 may include a conveyor definitions database 110, a vehicle group definitions database 112, a performance profiles database 114, one or more vehicle build plan databases 116, a vehicle sequence database 118, a conveyor performance profile database 120, and a simulation database 122. While FIG. 1 is shown as including a specific number of modules and databases, it should be apparent to those skilled in the art that the system 100 of FIG. 1 may include more or less modules and/or databases. For instance, two or more of the databases (or modules) shown in FIG. 1 may be combined.

In the example of FIG. 1, the historical vehicle sequence module 102 receives data from multiple sources, such as the vehicle group definitions database 112 and at least one of the vehicle build plan databases 116 and/or a vehicle sequence controller (not shown). For example, the historical vehicle sequence module 102 receives data representing identified vehicles groups having different vehicle characteristics stored in the vehicle group definitions database 112. In such examples, the vehicle characteristics may include body styles (e.g., truck frames, van frames, etc.), regular production options (RPOs), etc. The RPOs may include, for example, any option in addition to or reduction of a base vehicle setup, such as color, leather seats, four-wheel drive, no front seats, etc. Examples of identified vehicles groups may include trucks; not (˜) trucks; black trucks; black not (˜) trucks (e.g., black vans, etc.); not (˜) black vehicles; red not (˜) trucks; not (˜) red vehicles, not (˜) trucks, etc. Additionally, the historical vehicle sequence module 102 may optionally receive data representing specific build plans for vehicles having different vehicle characteristics stored in the vehicle build plan database 116. Such plans may include a particular order or sequence in which vehicle characteristics (e.g., RPOs) are assembled at different footprints of each conveyor of the assembly line. Further, in various embodiments, the historical vehicle sequence module 102 may optionally receive data representing (via an input 126 in FIG. 1) one or more actual vehicle sequences of vehicles passing through an assembly line from the vehicle sequence controller. In such examples, the historical vehicle sequence module 102 may receive the specific build plans for vehicles (from the vehicle build plan database 116) and/or the actual sequence of vehicles (from the vehicle sequence controller). Based on the received data from the vehicle group definitions database 112, and the vehicle build plan database 116 and/or the vehicle sequence controller, the historical vehicle sequence module 102 builds a set of historical vehicle sequences for the identified vehicles groups. Such historical vehicle sequences are then stored in the vehicle sequence database 118.

As shown in FIG. 1, the pass one simulator module 104 receives data representing conveyor content from the vehicle sequence database 118, the conveyor definitions database 110, and the performance profiles database 114. For example, the pass one simulator module 104 receives data representing historical vehicle sequences stored in the vehicle sequence database 118, and conveyor data (e.g., a name/ID of each conveyor of the assembly line, the number of footprints in each conveyor of the assembly line, etc.) stored in the conveyor definitions database 110. Additionally, the pass one simulator module 104 receives data, stored in the performance profiles database 114, representing determined performance profiles (e.g., over-cycle distributions) for the identified vehicles groups (stored in the vehicle group definitions database 112). For example, the performance profiles of the identified vehicles groups include over-cycle distributions of the identified vehicles groups at particular footprints of each conveyor and at different cycle times.

The pass one simulator module 104 then determines each conveyor's cycle time probability distributions for each cycle based on the received data from the vehicle sequence database 118, the conveyor definitions database 110, and the performance profiles database 114. For example (and as further explained below), for each cycle, the pass one simulator module 104 may determine a cumulative probability, for each footprint cycle time, across all of the footprints of the conveyor, of one or more of the footprints of the conveyor having that cycle time or less. In various embodiments, the pass one simulator module 104 may determine, for each cycle, the cumulative probability based on the received conveyor content (e.g., over-cycle distributions specific to vehicle groups at specific footprints for different footprint cycle times) for that cycle. Then, for each cycle, the pass one simulator module 104 may determine an individual probability, for each footprint cycle time, across all of the footprints, of the conveyor having that cycle time. In such examples, the individual probability for each footprint cycle time may be determined based on the cumulative probability for that footprint cycle time (N) and the cumulative probability for a previous footprint cycle time (N−1), as further explained below. The determined individual probabilities are then stored in the conveyor performance profile database 120.

With continued reference to FIG. 1, the pass two simulator module 106 receives data from the conveyor definitions database 110 and the conveyor performance profile database 120. For example, the pass two simulator module 106 receives data representing the conveyor data stored in the conveyor definitions database 110, and individual probabilities for footprint cycle times and cycles of each conveyor stored in the conveyor performance profile database 120. The pass two simulator module 106 may then perform a discrete event simulation of the conveyors of the assembly line based on the received individual probabilities, as further explained below. Results of the discrete event simulation may then be stored in the simulation database 122.

The evaluation module 108 may evaluate the results from the discrete event simulation performed by the pass two simulator module 106 and/or individual probabilities determined by the pass one simulator module 104. For example, the evaluation module 108 may receive (via an input 124) one or more vehicle dispatch strategies for the assembly line. Each vehicle dispatch strategy may include, for example, a vehicle sequence for advancing along footprints of each conveyor of the assembly line, a staffing plan indicating proposed amounts of workers at particular footprints at particular cycles (e.g., two workers at footprint X of conveyor Y for cycle Z, one worker at footprint A of conveyor B for cycle C, etc.), etc. The evaluation module 108 may then generate an alert (e.g., an alert signal) indicating an over-cycle risk for any one of the received vehicle dispatch strategies based on the individual probabilities determined by the pass one simulator module 104 and/or the results from the discrete event simulation.

In various embodiments, the evaluation module 108 may evaluate a proposed response to the alert. For example, staffing plans and/or the vehicle sequence may be changed in response to the generated alert to suppress the over-cycle risk at a particular footprint. In such examples, the evaluation module 108 may receive the proposed response (e.g., the change in the staffing plan, the change in the vehicle sequence of vehicle groups, etc.) to the alert, and evaluate the proposed response to the alert to determine an impact (e.g., a probability of over-cycling and a duration of over-cycle) of the response at one or more other footprints. For instance, the response to suppress the over-cycle risk at one footprint through additional dispatched resources (e.g., additional staffing, etc.) may result in over-cycling at another footprint on the same cycle or a different cycle, thereby mitigating the impact of suppressing the over-cycle risk at the former footprint. In such examples, the evaluation module 108 may alter the alert, generate a new alert, etc. based on the impact of the proposed response.

The proposed response to the alert may be evaluated in various manners. As one example, the proposed response may be simulated by forcing the performance of one footprint (e.g., the footprint having an over-cycle risk) to be on time (e.g., 0% probability of an over-cycle). Then, the pass one simulator module 104 may recompute the individual probabilities based on this forced performance (and other received data), as explained above. The pass two simulator module 106 may then run another discrete event simulation of the conveyors of the assembly line based on the recomputed individual probabilities. The results of the rerun discrete event simulation may then indicate if the response to suppress the over-cycle risk at the footprint causes over-cycling at another footprint on the same cycle or a different cycle.

Additionally, in various embodiments, the evaluation module 108 may evaluate and optimize the received vehicle dispatch strategies for a conveyor of the assembly line and/or for the entire assembly line including all conveyors and buffers therebetween. For example, the evaluation module 108 may generate a score (e.g., 1 through 100, etc.) for any one of the received vehicle dispatch strategies based on the determined individual probabilities and/or the results from the discrete event simulation. For instance, the evaluation module 108 may generate a score for a vehicle dispatch strategy for a conveyor of the assembly line based on the determined individual probabilities. In such examples, the states of the buffers are not considered. In other examples, the evaluation module 108 may generate a score for a vehicle dispatch strategy for the entire assembly line based on the results from the discrete event simulation. In this scenario, the states of the buffers are considered.

The generated score for the single conveyor of the assembly line and/or the generated score for the entire assembly line may be used to indicate whether the vehicle dispatch strategy is satisfactory or defective by comparing the score to a threshold, to other generated scores for other vehicle dispatch strategies, etc. In response to the score indicating a defective vehicle dispatch strategy, the evaluation module 108 may generate an alert, discard the vehicle dispatch strategy, and/or provide instructions to alter the vehicle dispatch strategy in an attempt to optimize the vehicle dispatch strategy. As such, the vehicle dispatch strategy may be optimized for a single conveyor and/or optimized for the entire assembly line.

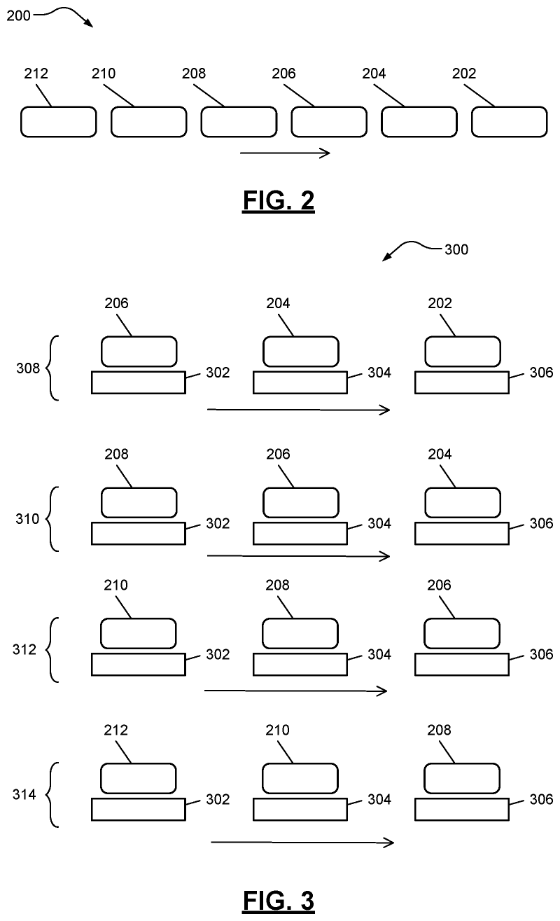

FIGS. 2-7 illustrate an example of simulating vehicles advancing through footprints of an assembly line by determining each conveyor's cycle time probability distributions for each cycle, and then leveraging such information in discrete event simulations by using each cycle's cycle time probability distributions to treat each conveyor as a single entity. In various embodiments, the pass one simulator module 104 may determine the cycle time probability distributions and the pass two simulator module 106 may perform the discrete event simulations. Although the example of FIGS. 2-7 is explained with reference to the modules 104, 106, it should be appreciated that other suitable modules may be employed.

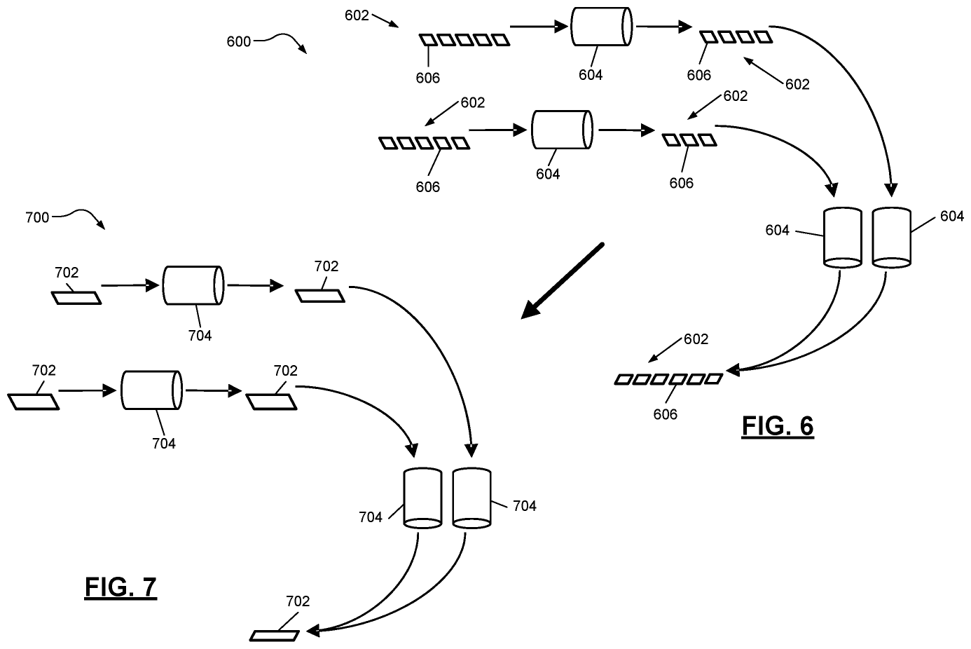

FIG. 2 depicts an example sequence 200 of vehicles having different vehicle characteristics. As shown, the sequence 200 includes vehicles 202, 204, 206, 208, 210, 212 in an order through the assembly line. In such examples, the assembly line includes multiple conveyors and a buffer between each set of adjacent conveyors (e.g., as shown in FIG. 6 and described below). Each buffer generally includes a defined buffer capacity, and functions as a holding area between conveyors in which vehicles exiting the end of one conveyor may be held before entering the beginning of the next conveyor.

FIG. 3 depicts an example sequence 300 of one conveyor of the assembly line. In this example, the conveyor includes three footprints 302, 304, 306, where the vehicles 202, 204, 206, 208, 210, 212 of FIG. 2 advance through the footprints 302, 304, 306 in four cycles 308, 310, 312, 314. For example, at cycle 308, the vehicle 202 is at footprint 306, the vehicle 204 is at footprint 304, and the vehicle 206 is at footprint 302. Additionally, at cycle 310, the vehicle 204 is at (e.g., advances to) footprint 306, the vehicle 206 is at footprint 304, and the vehicle 208 is at footprint 302; at cycle 312, the vehicle 206 is at footprint 306, the vehicle 208 is at footprint 304, and the vehicle 210 is at footprint 302; and at cycle 314, the vehicle 208 is at footprint 306, the vehicle 210 is at footprint 304, and the vehicle 212 is at footprint 302. In such examples, the vehicle 202 may be a black truck, the vehicle 204 may be a white truck, the vehicle 206 may be a black van, the vehicle 208 may be a red truck, the vehicle 210 may be a black truck (e.g., similar to the vehicle 202), and the vehicle 212 may be a white truck (e.g., similar to the vehicle 204). In the example of FIGS. 1-2, the sequences 200, 300 are shown in a simplified manner for clarity. With that said, it should be appreciated by those skilled in that art that more or less vehicles having different vehicle characteristics, more or less footprints, and/or more or less cycles may be employed.

As explained above, the pass one simulator module 104 receives performance profiles for identified vehicles groups advancing through conveyor footprints. For example, tables 1-3 below shows example over-cycle distributions of identified vehicles groups in the cycle 310 of FIG. 3 on particular footprints of one conveyor and at different cycle times. Specifically, table 1 shows over-cycle distributions for the groups of trucks and not trucks in the cycle 310 at the footprint 302 of FIG. 3, table 2 shows over-cycle distributions for the groups of black trucks, black not trucks, and not black vehicles in the cycle 310 at the footprint 304 of FIG. 3, and table 3 shows over-cycle distributions for the groups of trucks, red not trucks, and not red and not trucks in the cycle 310 at the footprint 306 of FIG. 3. Although tables 1-3 show only over-cycle distributions of specific identified vehicles groups at specific footprints in the cycle 310, it should be appreciated that the pass one simulator module 104 may receive similar over-cycle distributions for identified vehicles groups at each footprint, for each cycle, and for each conveyor in the assembly line.

TABLE 1
Footprint 302; Cycle 310

| Group | | | | | | |
|---|---|---|---|---|---|---|
| Name | 60 sec | 61 sec | 62 sec | 63 sec | 64 sec | Cycle Time |
| Trucks | 59% | 15% | 12% | 9% | 5% | Over-Cycle |
| Not | 78% | 9% | 8% | 4% | 1% | Distributions |
| Trucks | | | | | | |

TABLE 2
Footprint 304; Cycle 310

| Group | | | | | | |
|---|---|---|---|---|---|---|
| Name | 60 sec | 61 sec | 62 sec | 63 sec | 64 sec | Cycle Time |
| Black | 31% | 15% | 23% | 8% | 23% | Over-Cycle |
| Trucks | | | | | | Distributions |
| Black Not | 57% | 4% | 13% | 9% | 17% | |
| Trucks | | | | | | |
| Not Black | 73% | 14% | 13% | 0% | 0% | |
| Vehicles | | | | | | |

TABLE 3
Footprint 306; Cycle 310

| Group | | | | | | |
|---|---|---|---|---|---|---|
| Name | 60 sec | 61 sec | 62 sec | 63 sec | 64 sec | Cycle Time |
| Trucks | 67% | 17% | 12% | 4% | 0% | Over-Cycle |
| Red Not | 89% | 4% | 3% | 3% | 1% | Distributions |
| Trucks | | | | | | |
| Not Red | 79% | 12% | 5% | 4% | 0% | |
| Not | | | | | | |
| Trucks | | | | | | |

Then, the pass one simulator module 104 determines a cumulative probability, for each footprint cycle time, across all of the footprints of the conveyor, of one or more of the footprints of the conveyor having that cycle time or less. The determination of each cumulative probability is made based on conveyor content for each conveyor, which is ascertained (in this example) from the example sequences 200, 300 of FIGS. 2-3 and tables 1-3 above. For example, at the cycle 310 of FIG. 3, the vehicle 208 (e.g., a red truck) is at footprint 302, the vehicle 206 (e.g., a black van) is at footprint 304, and the vehicle 204 (e.g., a white truck) is at footprint 306.

For each cycle, the pass one simulator module 104 may determine the cumulative probability, for each footprint cycle time, across all of the footprints of the conveyor by multiplying a set of the over-cycle distributions for that cycle according to the conveyor content. For example, at cycle 310 and for a cycle time of 60 seconds, the pass one simulator module 104 selects 59% (the over-cycle distribution corresponding to the group of trucks at footprint 302), 57% (the over-cycle distribution corresponding to the black not trucks at footprint 304), and 67% (the over-cycle distribution corresponding to the group of trucks at footprint 306) because, at cycle 310 of FIG. 3, a red truck (the vehicle 208) is at footprint 302, a black van (the vehicle 206) is at footprint 304, and a white truck (the vehicle 204) is at footprint 306. The pass one simulator module 104 then multiplies the set of over-cycle distributions (59%*57%*67%) to obtain the cumulative probability (22.5321%) for a cycle time of 60 seconds at cycle 310, as shown in table 4 below.

Additionally, a cumulative probability for each other footprint cycle times may be calculated in a similar manner taking into account that cycle time and smaller cycle times. For example, at cycle 310 and for a cycle time of 61 seconds, the pass one simulator module 104 selects 59% and 15% (the over-cycle distributions corresponding to the group of trucks at footprint 302 and at cycle times 60 and 61, respectively), 57% and 4% (the over-cycle distributions corresponding to the black not trucks at footprint 304 and at cycle times 60 and 61, respectively), and 67% and 17% (the over-cycle distributions corresponding to the group of trucks at footprint 306 and at cycle times 60 and 61, respectively). The pass one simulator module 104 then sums the over-cycle distributions in each footprint (e.g., 59%+15%, 57%+4%, and 67%+17%) to obtain a set of over-cycle distributions for each footprint and multiplies the set of over-cycle distributions to obtain the cumulative probability (37.9176%) for a cycle time of 61 seconds at cycle 310, as shown in table 4 below. The determined cumulative probabilities at the footprint cycle times of 62 seconds, 63 seconds, and 64 seconds are calculated in a similar manner, and are shown in table 4 below.

TABLE 4
Cycle 310

| | | Cumulative |
|---|---|---|
| Cycle Time | Over-Cycle Distributions From Tables 1-3 | Probability |
| 60 sec | 59% * 57% * 67%= | 22.5321% |
| 61 sec | (59% + 15%) * | 37.9176% |
| | (57% + 4%) * | |
| | (67% + 17%)= | |
| 62 sec | (59% + 15% + 12%) * | 61.0944% |
| | (57% + 4% + 13%) * | |
| | (67% + 17% + 12%)= | |
| 63 sec | (59% + 15% + 12% + 9%) * | 78.85% |
| | (57% + 4% + 13% + 9%) * | |
| | (67% + 17% + 12% + 4%)= | |
| 64 sec | (59% + 15% + 12% + 9% + 5%) * | 100% |
| | (57% + 4% + 13% + 9% + 17%) * | |
| | (67% + 17% + 12% + 4% + 0%)= | |

Then, the pass one simulator module 104 determines an individual probability, for each footprint cycle time, across all of the footprints, of the conveyor having that cycle time. The determination of each individual probability is made based on the cumulative probability for that footprint cycle time (N) and the cumulative probability for a previous footprint cycle time (N−1).

For example, for each cycle, the pass one simulator module 104 may determine the individual probability, for each footprint cycle time, across all of the footprints of the conveyor, by subtracting the cumulative probability for the previous footprint cycle time (N−1) from the cumulative probability for that footprint cycle time (N). For example, at cycle 310 and for a cycle time of 60 seconds, the pass one simulator module 104 subtracts zero (no previous footprint cycle time) from the cumulative probability (22.5321%) at the cycle time of 60 to obtain the individual probability (22.5321%) for a cycle time of 60 seconds at cycle 310, as shown in table 5 below. Additionally, at cycle 310 and for a cycle time of 61 seconds, the pass one simulator module 104 subtracts the cumulative probability (22.5321%) at the cycle time of 60 from the cumulative probability (37.9176%) at the cycle time of 61 to obtain the individual probability (15.3855%) for a cycle time of 61 seconds at cycle 310, as shown in table 5 below. The determined individual probabilities at the footprint cycle times of 62 seconds, 63 seconds, and 64 seconds are calculated in a similar manner, and are shown in table 5 below.

TABLE 5
Cycle 310

| | | Individual |
|---|---|---|
| Cycle Time | Cumulative Probabilities From Table 4 | Probability |
| 60 sec | 22.5321% − 0%= | 22.5321% |
| 61 sec | 37.9176% − 22.5321% | 15.3855% |
| 62 sec | 61.0944% − 37.9176% | 23.1768% |
| 64 sec | 78.85% − 61.0944% | 17.7556% |
| 64 sec | 100% − 78.85% | 21.15% |

Then, the pass one simulator module 104 may store the determined individual probabilities for each cycle and each conveyor in the conveyor performance profile database 120. For example, FIG. 4 illustrates an example table 400 for storing determined individual probabilities of the different cycles 1, 2, etc. (collectively, cycles 404) at different footprint cycle times of 60, 61, 62, 63, and 64 seconds (collectively, cycle times 402). In this example, the cycles 1, 2 may correspond to the cycles 308, 310 of FIG. 3. As such, the determined individual probabilities of the cycle 310 from table 5 above are shown as an example in the cycle 2 of FIG. 4.

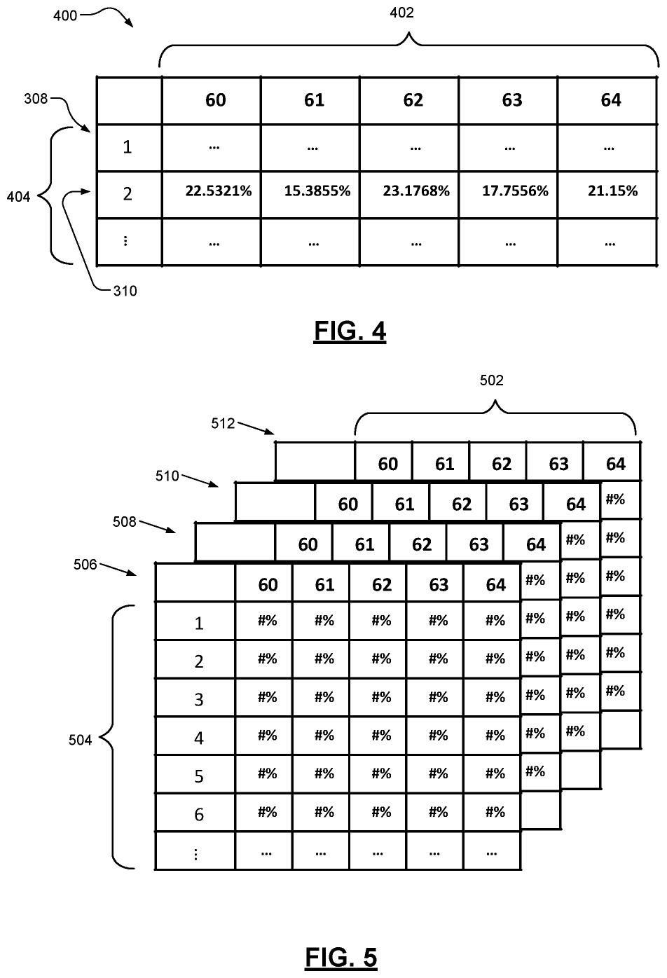

Additionally, the determined individual probabilities for each cycle and each conveyor may be stored in a library of tables. For example, FIG. 5 illustrates a collection of tables 506, 508, 510, 512 each corresponding to a different conveyor of the assembly line. As shown, each table 506, 508, 510, 512 stores determined individual probabilities of different cycles 1, 2, etc. (collectively, cycles 504) at different footprint cycle times of 60, 61, 62, 63, 64 seconds (collectively, cycle times 502). In the example of FIG. 5, one cycle (e.g., cycle 2) of the table 506 may be populated with the determined individual probabilities from table 5 above (or from the table 4 of FIG. 4).

The pass two simulator module 106 may then perform one or more discrete event simulations of the conveyors using one of the determined individual probabilities for each cycle and conveyor. For example, and as further explained below, the pass two simulator module 106 may use the determined individual probabilities for each cycle and conveyor to treat each conveyor as a single entity in a discrete event simulation and to obtain a simulated conveyor cycle time for each conveyor. In such examples, the simulated conveyor cycle time for each conveyor is an aggregated time for that conveyor with each footprint of the conveyor experiencing the same resulting cycle time. By relying on the previously calculated individual probabilities, footprint distribution outcome calculations for a given cycle are eliminated and do not have to be repeated for each of the thousands of simulations of a production period. As such, the pass two simulator module 106 may perform thousands of simulations of tens of thousands of vehicles (e.g., 40,000 vehicles, etc.) advancing through the assembly line of vast amounts of footprints (e.g., 400 footprints, etc.) in a computationally feasible way.

For example, FIGS. 6-7 depict simulation diagrams 600, 700 of the same assembly line. As shown in FIG. 6, the assembly line includes five conveyors 602 and four buffers 604. Each buffer 604 functions as a holding area between adjacent conveyors 602 in which vehicles exiting the end of one conveyor may be held before entering the beginning of the next conveyor. Each buffer 604 generally includes a defined buffer capacity. In the simulation diagram 600, each conveyor 602 includes multiple footprints 606 (e.g., three footprints, four footprints, five footprints, six footprints, etc.) where content of the vehicle is assembled during a cycle. In FIG. 7, the assembly line includes conveyors five conveyors 702 and four buffers 704, corresponding to the conveyors 602 and the buffers 604 of FIG. 6. In contrast to the conveyers 602 of FIG. 6, each conveyor 702 of FIG. 7 is treated as a single entity. While FIG. 6 illustrates a simplistic example of an assembly line having only five conveyors 602 with a total of 23 footprints, it should be appreciated that the assembly line may include many more conveyors (e.g., 10 conveyors, 13 conveyors, 15 conveyors, 20 conveyors, etc.) and footprints (e.g., 300 footprints, 350 footprints, 400 footprints, 450 footprints, etc.). In such examples, each conveyor may still be treated as a single entity no matter the number of footprints contained therein.

In various embodiments, discrete event simulations of conveyors may be achieved through the advancement of pointers for the conveyors. For example, the pass two simulator module 106 may perform a discrete event simulation by generating a random number (e.g., between 0 and 1) for each conveyor and then indexing that random number for each conveyor into an applicable cycle for that conveyor stored in one or more tables (e.g., the tables 506, 508, 510, 512 of FIG. 5). In such examples, the content of each buffer is represented by tail plus one (tail+1) and head minus one (head−1) cycle pointers of the upstream and downstream conveyors from that buffer in order to maintain a defined buffer capacity for each buffer and a relationship between the upstream and downstream conveyors, as explained below. As such, each generation and subsequent index of a random number for each conveyor advances a pointer for that conveyor such that multiple discrete event simulations of the conveyors may be performed.

For instance, the pass two simulator module 106 may generate a random number of 0.87 for the conveyor (e.g., conveyor 1) corresponding to the table 506 of FIG. 5 and a random number of 0.65 for the conveyor (e.g., conveyor 2) corresponding to the table 508 of FIG. 5. Then, the pass two simulator module 106 may index the random number for the conveyor 1 into an applicable cycle of the table 506 (e.g., cycle 2 having a range of individual probability values for each footprint cycle time), and index the random number for the conveyor 2 into an applicable cycle of the table 508 (e.g., cycle 4 having a range of individual probability values for each footprint cycle time). The pass two simulator module 106 may then obtain a simulated conveyor cycle time (e.g., 60, 61, 62, 63, 64 seconds) for the applicable cycle on each conveyor 1, 2 stored in the tables 506, 508, according to each indexed random number. For example, cycle 2 of conveyor 1 may have a range of individual probability values of between 0.869 and 0.871 for a cycle time of 62 seconds, and cycle 4 of conveyor 2 may have a range of individual probability values of between 0.63 and 0.65 for a cycle time of 64 seconds. In such examples, the pass two simulator module 106 may then obtain a simulated conveyor cycle time of 62 seconds for conveyor 1 at cycle 2 and a simulated conveyor cycle time of 64 seconds for conveyor 2 at cycle 4.

Additionally, the pass two simulator module 106 may perform another discrete event simulation of the conveyors by generating another random number for each conveyor and indexing the other random number for each conveyor into an applicable cycle for that conveyor to obtain another simulated conveyor cycle time on each conveyor, as explained above.

Further, the pass two simulator module 106 may simulate buffers (e.g., the buffers 702 of FIG. 7) between adjacent conveyors by employing the tail plus one (tail+1) and head minus one (head−1) cycle pointers of the upstream and downstream conveyors from each buffer. For example, the pass two simulator module 106 may maintain a defined buffer capacity for each buffer (e.g., a minimum capacity of vehicles in each buffer and a maximum capacity of vehicles in each buffer), and a relationship between the end of one conveyor (e.g., the upstream conveyor) and the beginning of the next conveyor (e.g., the downstream conveyor) on opposing sides of each buffer. The contents of each buffer may be then be managed based on the defined buffer capacity and the relationship between conveyors.

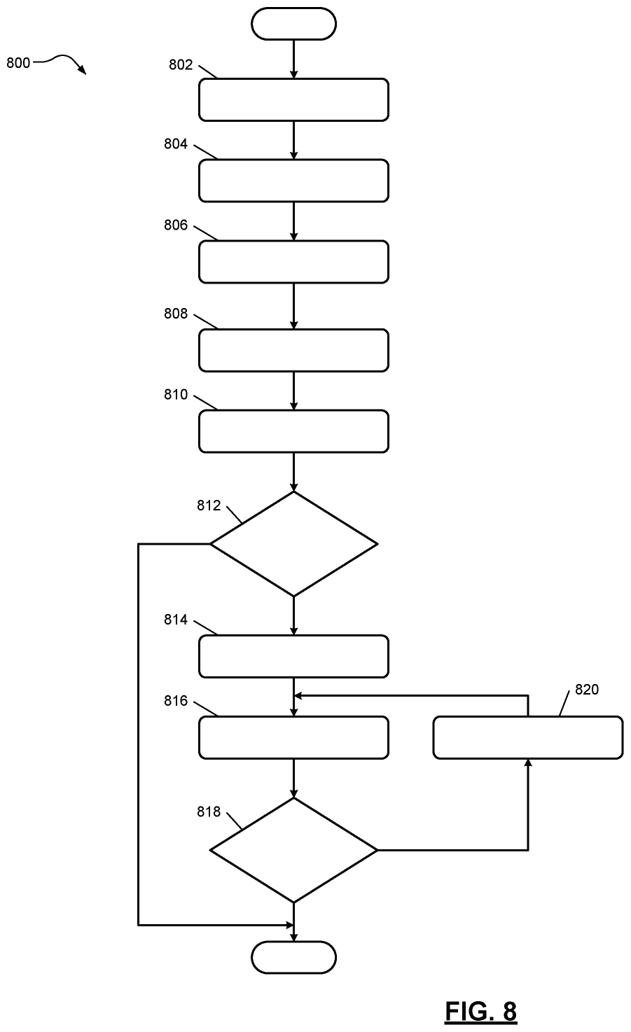

FIG. 8 illustrates an example control process 800 for simulating cycle times of conveyors of an assembly line employable by the system 100 of FIG. 1. Although the control process 800 is described in relation to the system 100 of FIG. 1, the control process 800 may be employable by any suitable system.

As shown in FIG. 8, control begins at 802 where the pass one simulator module 104 receives conveyor content including over-cycle distributions specific to vehicle groups at specific footprints for different footprint cycle times, as shown in the example tables 1-3 above. Control then proceeds to 804.

At 804, the pass one simulator module 104 determines (e.g., calculates) a cumulative probability, for each footprint cycle time, across all of the footprints of the conveyor. Each cumulative probability represents a probability of one or more of the footprints of the conveyor having that cycle time or less. The cumulative probability determinations are made for each cycle and for each conveyor of the assembly line. As explained above, the cumulative probability determinations may include multiplying a set of over-cycle distributions according to the conveyor content for each cycle. Table 4 above shows one example of determined cumulative probabilities at different footprint cycle times for one particular cycle. Control then proceeds to 806.

At 806, the pass one simulator module 104 determines (e.g., calculates) an individual probability for each footprint cycle time, across all of the footprints of a given conveyor. Each individual probability represents a probability of the conveyor having that cycle time. The individual probability determinations are made for each cycle and for each conveyor of the assembly line. In various embodiments, the individual probability for each footprint cycle time may be determined based on the difference between a cumulative probability for that footprint cycle time (N) and a cumulative probability for the previous footprint cycle time (N−1), as explained above. Table 5 above shows one example of determined individual probabilities at different footprint cycle times for one particular cycle. Control then proceeds to 808.

At 808, control receives a vehicle dispatch strategy for the assembly line. For example, the vehicle dispatch strategy may include a vehicle sequence for advancing along footprints of each conveyor of the assembly line, a staffing plan indicating proposed amounts of workers at particular footprints at particular cycles, etc.

Control then proceeds to 810, where a score associated with the vehicle dispatch strategy is generated (e.g., by the evaluation module 108 of FIG. 1). For example, a score for the received vehicle dispatch strategy may be generated based on one or more of the determined individual probabilities of 806. Control then proceeds to 812.

At 812, control determines whether the generated score is above a threshold. For example, the generated score may be used to indicate whether the vehicle dispatch strategy is satisfactory or defective by comparing the score to the threshold. If so at 812, control may end or return to another step, such as 808 to receive another vehicle dispatch strategy. Otherwise, control proceeds to 814 where control generates an alert (e.g., an alert signal) indicating, for example, an over-cycle risk for the vehicle dispatch strategy. Control then proceeds to 816.

At 816, control receives and evaluates a proposed response to the alert, as explained above. For example, and as explained above, staffing plans, a vehicle sequence, etc. may be changed in response to the generated alert to suppress the over-cycle risk at a particular footprint. Control then proceeds to 818.

At 818, control determines whether the impact of the response is acceptable. For instance, the response to suppress the over-cycle risk at one footprint through additional dispatched resources (e.g., additional staffing, etc.) may result in over-cycling at another footprint on the same cycle or a different cycle or may be unnecessary because a downstream buffer is at its capacity. If the impact of the response is acceptable at 818, control may end or return to another step, such as 808 to receive another vehicle dispatch strategy, 816 to receive and evaluate another proposed response to the alert, etc. If the impact of the response is not acceptable at 818, control proceeds to 820 where control may alter the alert, generate a new alert, etc. based on the impact of the proposed response. Control then returns to 816 to receive and evaluate another proposed response to the alerted or new alert.

In various embodiments, the vehicle dispatch strategy may be discarded or altered if, for example, the generated score at 812 is below the threshold. Such actions may occur in addition to (or instead of) generating the alert at 814 and subsequent steps. In such examples, the evaluation module 108 may propose changes to the vehicle dispatch strategy, provide instructions to alter the vehicle dispatch strategy, etc. in an attempt to optimize the vehicle dispatch strategy.

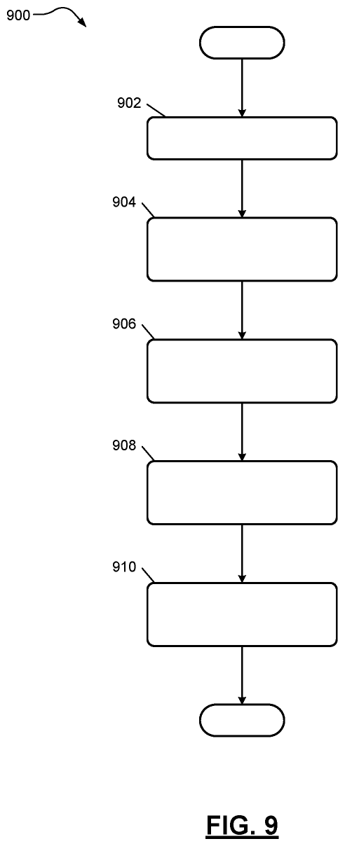

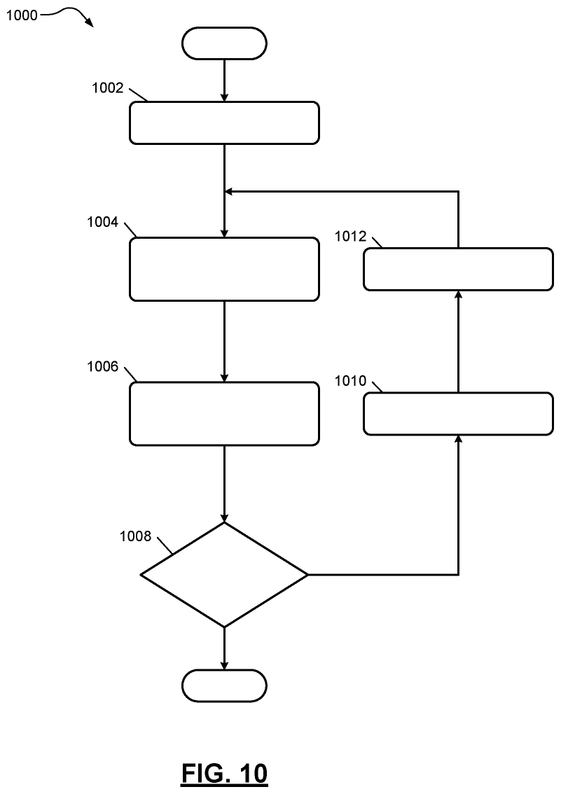

FIG. 9 illustrates an example control process 900 for simulating conveyors of an assembly line employable by the system 100 of FIG. 1. Although the control process 900 is described in relation to the system 100 of FIG. 1, the control process 900 may be employable by any suitable system.

As shown in FIG. 9, control begins at 902 where the pass one simulator module 104 receives conveyor content as explained above relative to FIG. 8. Control then proceeds to 904, 906 where the pass one simulator module 104 determines cumulative probabilities and individual probabilities for each cycle and for each conveyor as explained above relative to FIG. 8.

Control then proceeds to 908, where control stores the determined individual probabilities for each cycle of each conveyor into tables. For example, and as explained above, the determined individual probabilities for each cycle of each conveyor may be stored in a library of tables (e.g., the tables 506, 508, 510, 512 of FIG. 5) of a database (e.g., the conveyor performance profile database 120 of FIG. 1). Control then proceeds to 910.

At 910, control performs one or more discrete event simulations of the conveyors using one of the determined individual probabilities for each cycle and conveyor. For example, the pass two simulator module 106 of FIG. 1 may use the determined individual probabilities for each cycle and conveyor to treat each conveyor as a single entity in a discrete event simulation and to obtain a simulated cycle time cycle time for each conveyor, as explained herein. Such discrete event simulations may be performed by generating and indexing random numbers for ach conveyor as explained herein.

For example, FIG. 10 illustrates an example control process 1000 for performing discrete event simulations employable by the system 100 of FIG. 1. Although the control process 1000 is described in relation to the system 100 of FIG. 1, the control process 1000 may be employable by any suitable system.

As shown, control begins at 1002 where the pass two simulator module 106 generates a random number for each conveyor of an assembly line. This may be, for example, an initial step of a discrete event simulation. Control then proceeds to 1004.

At 1004, the pass two simulator module 106 indexes the random number for each conveyor into an applicable cycle for that conveyor. For example, each cycle may have a range of previously determined individual probability values for each footprint cycle time stored one or more tables (e.g., the tables 506, 508, 510, 512 of FIG. 5), as explained herein. The random number may then be indexed to an applicable cycle and footprint cycle time. Control then proceeds to 1006, where the pass two simulator module 106 obtains a conveyor cycle time for each conveyor based on the indexed random number for that conveyor. In such examples, the conveyor cycle time for each conveyor is an aggregated time for that conveyor with each footprint of the conveyor experiencing the same resulting cycle time.

Control then proceeds to 1008, where the pass two simulator module 106 determines whether to perform another discrete event cycle simulation. This determination may be made based on, for example, a defined number of simulations to run, received simulation instructions, etc. If so at 1008, control proceeds to 1010. Otherwise, control may end.

At 1010, control advances each simulated conveyor is to the next cycle. For example, and as explained above relative to FIG. 3, vehicles advance through footprints of each conveyor in cycles. As such, when each conveyor is advanced to the next cycle, each vehicle on that conveyor advances to the next footprint (or to a buffer if the footprint is the last footprint in the conveyor). Control then proceeds to 1012, where the pass two simulator module 106 generates a new random number for each conveyor of the assembly line. Control then returns to 1004.

While the control process 1000 of FIG. 10 is described as performing discrete event simulations for a conveyor, it should be appreciated that such discrete event simulations are performed on all conveyors of the assembly line. Further, the discrete event simulations may be executed asynchronously for each conveyor of the assembly line while allowing the time-based content of the buffers driving the availability of the cycle to complete. Otherwise, starvation of a buffer upstream or an overflow of a buffer downstream may occur.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for simulating cycle times of conveyors of an assembly line, each conveyor configured to advance vehicles through a plurality of footprints representing a location where vehicle content is assembled, the method comprising:
receiving, for each conveyor, conveyor content for each cycle, the conveyor content including over-cycle distributions each specific to a vehicle group at a footprint of each conveyor for a footprint cycle time;
for each cycle and for each conveyor:
determining a cumulative probability, for each footprint cycle time, across all of the footprints of the conveyor, of one or more of the footprints of the conveyor having that cycle time or less, wherein the cumulative probability for each footprint cycle time is determined based on the conveyor content for the conveyor; and
determining an individual probability, for each footprint cycle time, across all of the footprints, of the conveyor having that cycle time, wherein the individual probability for each footprint cycle time is determined based on the cumulative probability for that footprint cycle time (N) and the cumulative probability for a previous footprint cycle time (N−1);
receiving at least one vehicle dispatch strategy for the assembly line; and
generating an alert indicating an over-cycle risk for the at least one vehicle dispatch strategy based on the determined individual probabilities.

2. The method of claim 1 further comprising:
generating a score for the received vehicle dispatch strategy based on the determined individual probabilities; and
optimizing the received vehicle dispatch strategy based on the generated score.

3. The method of claim 1 wherein:
the received vehicle dispatch strategy includes a vehicle sequence and a staffing plan; and
the method further comprises evaluating a response to the alert to determine an impact of the response, wherein the response includes a change in the staffing plan or a change in the vehicle sequence of vehicle groups.

4. The method of claim 3 further comprising altering the alert based on the impact of the response.

5. The method of claim 1 wherein, for each cycle and for each conveyor:
determining the cumulative probability, for each footprint cycle time, across all of the footprints of the conveyor, includes multiplying a set of the over-cycle distributions for that cycle time that are less than or equal to the cycle time.

6. The method of claim 1 wherein, for each cycle and for each conveyor:
determining the individual probability, for each footprint cycle time, across all of the footprints of the conveyor, includes subtracting the cumulative probability for the previous footprint cycle time (N−1) from the cumulative probability for that footprint cycle time (N).

7. The method of claim 1 further comprising performing a discrete event simulation of the conveyors using one of the determined individual probabilities for each cycle and for each conveyor.

8. The method of claim 7 wherein performing the discrete event simulation of the conveyors includes generating a random number for each conveyor and indexing the random number for each conveyor into an applicable cycle for that conveyor to obtain a simulated conveyor cycle time for each conveyor.

9. The method of claim 8 further comprising performing another discrete event simulation of the conveyors by generating another random number for each conveyor and indexing the other random number for each conveyor into an applicable cycle for that conveyor to obtain another simulated conveyor cycle time for each conveyor.

10. The method of claim 8 further comprising simulating a buffer between two of the conveyors based on a defined buffer capacity and a relationship between the end of one conveyor and the beginning of the other conveyor.

11. A method for simulating conveyors of an assembly line, each conveyor configured to advance vehicles through a plurality of footprints representing a location where vehicle content is assembled, the method comprising:
receiving, for each conveyor, conveyor content for each cycle, the conveyor content including over-cycle distributions each specific to a vehicle group at a footprint of each conveyor for a footprint cycle time;
for each cycle and for each conveyor:
determining a cumulative probability, for each footprint cycle time, across all of the footprints of the conveyor, of one or more of the footprints of the conveyor having that cycle time or less, wherein the cumulative probability for each footprint cycle time is determined based on the conveyor content for the conveyor; and
determining an individual probability, for each footprint cycle time, across all of the footprints of the conveyor, of the conveyor having that cycle time, wherein the individual probability for each footprint cycle time is determined based on the cumulative probability for that footprint cycle time (N) and the cumulative probability for a previous footprint cycle time (N−1); and
performing a discrete event simulation of the conveyors using one of the determined individual probabilities for each cycle and for each conveyor.

12. The method of claim 11 wherein performing the discrete event simulation of the conveyors includes generating a random number for each conveyor and indexing the random number for each conveyor into an applicable cycle for that conveyor to obtain a simulated conveyor cycle time for each conveyor.

13. The method of claim 12 further comprising performing another discrete event simulation of the conveyors by generating another random number for each conveyor and indexing the other random number for each conveyor into an applicable cycle for that conveyor to obtain another simulated conveyor cycle time for each conveyor.

14. The method of claim 12 further comprising simulating a buffer between two of the conveyors based on a defined buffer capacity and a relationship between the end of one conveyor and the beginning of the other conveyor.

15. The method of claim 14 further comprising:
receiving at least one vehicle dispatch strategy for the assembly line; and
generating an alert indicating an over-cycle risk for the vehicle dispatch strategy based on the discrete event simulation.

16. The method of claim 15 wherein:
the received vehicle dispatch strategy includes a vehicle sequence and/or a staffing plan; and
the method further comprises evaluating a response to the alert to determine an impact of the response, wherein the response includes a change in the staffing plan or a change in the vehicle sequence of vehicle groups.

17. The method of claim 16 wherein evaluating the response to the alert to determine the impact of the response includes simulating performance of one of the footprints to have a zero percent probability of an over-cycle, and, for each cycle and for each conveyor, determining the cumulative probability and the individual probability, for each footprint cycle time, across all of the footprints of the conveyor, based on the simulated performance of the footprint.

18. The method of claim 12 further comprising:
receiving at least one vehicle dispatch strategy for the assembly line;
generating a score for the vehicle dispatch strategy based on the discrete event simulation; and
optimizing the vehicle dispatch strategy based on the generated score.
